(19) United States
(12) Patent Application Publication
(10) Pub. No.: US 2019/0303745 A1
(43) Pub. Date: Oct. 3, 2019

(54) ARTIFICIAL NEURAL NETWORK

(71) Applicant: HON HAI PRECISION INDUSTRY CO., LTD., New Taipei (TW)

(72) Inventor: JUNG-YI LIN, New Taipei (TW)

(21) Appl. No.: 15/950,257

(22) Filed: Apr. 11, 2018

(30) Foreign Application Priority Data
Mar. 27, 2018 (TW) 107110388

(51) Int. Cl. G06N 3/04; G06N 3/063

(52) U.S. Cl. CPC G06N 3/0454; G06N 3/063

(57) ABSTRACT

An artificial neural network includes an input layer, a hidden layer, and an output layer which include first, second, and third neurons respectively. The hidden layer is divided into a plurality of planes arranged along a direction between the input layer and the output layer. The first neurons are connected to the second neurons positioned at one plane adjacent to the input layer. The third neurons are connected to the second neurons positioned at another plane adjacent to the output layer. The second neurons positioned at the same plane are connected to each other. The neurons positioned at two adjacent planes along the arranging direction of the planes are connected to each other. At least one of the neurons has at least six signal connections along the arranging direction of the planes and towards the other neurons on the same plane.

### FIELD

The subject matter relates to neural network models, and more particularly, to an artificial neural network.

### BACKGROUND

Artificial neural networks (ANNs) are computing systems inspired by the biological neural networks that constitute animal brains. Such an ANN “learns” tasks by considering examples, generally without task-specific programming. An ANN is based on a collection of artificial neurons. Each connection between artificial neurons can transmit a signal from one artificial neuron to another. The artificial neuron that receives the signal can process the signal and transmit the processed signal to the artificial neurons connected to the artificial neuron that originally received the signal.

In ANN implementations, the output of each artificial neuron is calculated by a non-linear function of the sum of its inputs, which may need a great amount of calculation and lower the efficiency for calculation. Furthermore, the artificial neuron transmits the signal to the artificial neurons connected to it along a single direction, for example, from the input layer to the hidden layer, or from the hidden layer to the output layer. The signal transmission along the single direction may result in a poor learning.

Thus, there is room for improvement within the art.

### BRIEF DESCRIPTION OF THE DRAWINGS

Implementations of the present technology will now be described, by way of example only, with reference to the attached figures.

FIG. 1 is a diagrammatic view of an embodiment of an artificial neural network of the present disclosure.

FIG. 2 is a diagrammatic view of the artificial neural network with an input layer and an output layer.

FIG. 3 is a vertical view of the artificial neural network of FIG. 1.

FIG. 4 is a side view of the artificial neural network of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

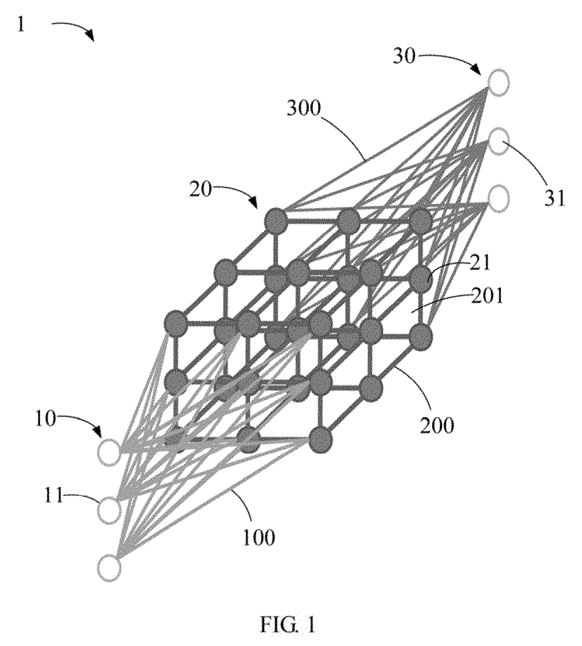

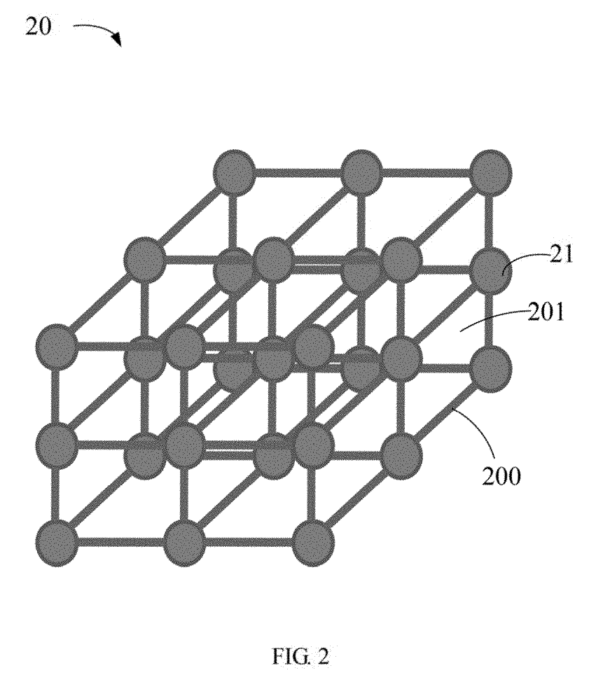

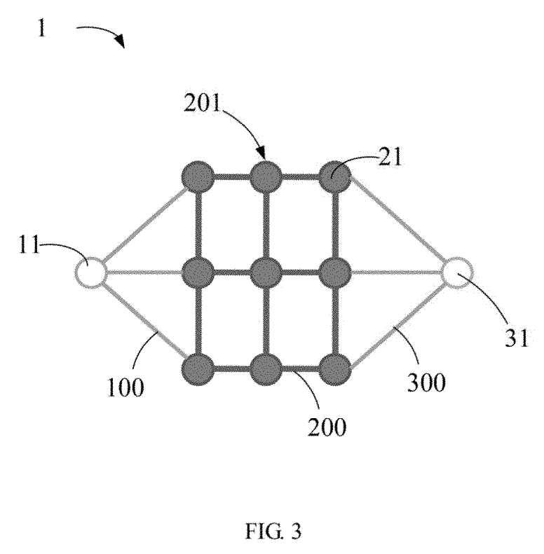

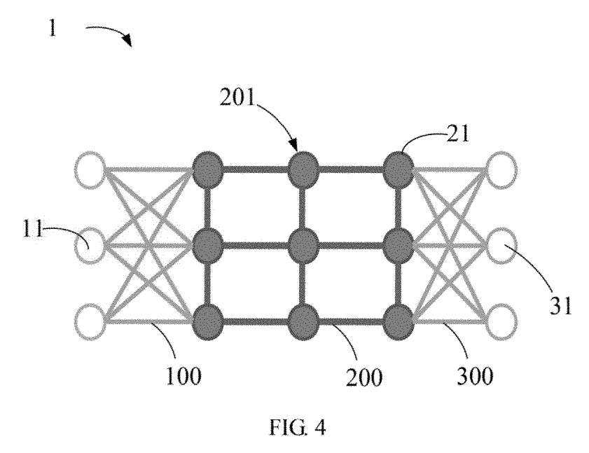

FIGS. 1 to 4 illustrate an embodiment of an artificial neural network 1. The artificial neural network 1 comprises an input layer 10, an output layer 30, and a hidden layer 20 positioned between the input layer 10 and the output layer 30.

The input layer 10 comprises a plurality of first artificial neurons 11. The hidden layer 20 comprises a plurality of second artificial neurons 21. The output layer 30 comprises a plurality of third artificial neurons 31.

The first artificial neurons 11 are connected to the second artificial neurons 21 through first communication channels 100. Each first artificial neuron 11 receives signals input from a database (not shown), calculates a signal by a non-linear function of a sum of the input signals, and outputs the signal to the second artificial neurons 21 connected thereto. The second artificial neurons 21 are connected to each other through second communication channels 200, and are connected to the third artificial neurons 31 through third communication channels 300. Each second artificial neuron 21 receives the signals from the first artificial neurons 11, calculates a signal by a non-linear function of a sum of the input signals, and outputs the signal to other second artificial neurons 21, the third artificial neurons 31, and the first artificial neurons 11 connected thereto.

Each of the input layer 10 and the output layer 30 has a two-dimensional (2D) structure. The first artificial neurons 11 and the third artificial neurons 31 constitute the 2D structures of the input layer 10 and the output layer 30, respectively.

The hidden layer 20 has a three-dimensional (3D) structure. The second artificial neurons 21 constitute the 2D structure of the hidden layer 20. The hidden layer 20 is divided into a plurality of planes 201. The planes 201 are parallel to and spaced apart from each other. The planes 201 are arranged along a certain direction between the input layer 10 and the output layer 30 (hereinafter, “arranging direction”). The second artificial neurons 21 are positioned at the planes 201.

Each first artificial neuron 11 is connected to each second artificial neuron 21 of one plane 201 adjacent to the input layer 10. Each third artificial neuron 31 is connected to each second artificial neuron 21 of another plane 201 adjacent to the output layer 30. The second artificial neurons 21 of each plane 201 are connected to each other. The second artificial neurons 21 of each two adjacent planes 201 are connected along the arranging direction of the planes 201. At least one second artificial neuron 21 of the hidden layer 20 has at least six signal transmission directions, along the arranging direction of the planes 201 and toward other second artificial neurons 21 of the same plane 201.

In at least one embodiment, the hidden layer 20 is substantially cubic, and has N planes 201 along the arranging direction (three planes 201 are shown in the figures, that is, N=3). Each plane 201 is substantially square, and has M second artificial neurons 21 (M=P×P, in the example, P=3, M=9). The second artificial neurons 21 of each plane 201 have 2P(P−1) signal connections. The second artificial neurons 21 of each two adjacent planes 201 have M signal connections. Thus, the second artificial neurons 21 of the hidden layer 20 have [2P(P−1)+M](N−1) signal connections.

In this embodiment, each second artificial neuron 21 at the corner of the hidden layer 20 has three signal connections. Each second artificial neuron 21 at the outer surface of the hidden layer 20 has five signal connections. The second artificial neuron 21 at the geometrical center of the hidden layer 20 has six signal connections.

Taking a conventional artificial neural network having the same plurality of artificial neurons as the artificial neural network 1 for example. The conventional artificial neural network has N hidden layers, each hidden layer has M artificial neurons, thus the hidden layers have a total of M^{N} signal connections. In comparison, the hidden layer 20 of the artificial neural network 1 of the present disclosure has fewer total signal connections. This can decrease the amount of calculates the system must make, therefore improving the calculation efficiency of the artificial neural network 1. Furthermore, since at least one second artificial neuron 21 of the hidden layer 20 has at least six signal connections along the arranging direction and toward other second artificial neurons 21 of the same plane 201, the second artificial neuron 21 can output the signal along at least six signal transmission directions. Thus, the learning effect of the artificial neural network 1 is improved.

In other embodiments, the shape of the hidden layer 20, the shape and the number of the planes 201, the number of second artificial neurons 21 of each plane 201 can be varied as needed, thereby changing the number of signal connections of the hidden layer 20.

Even though information and advantages of the present embodiments have been set forth in the foregoing description, together with details of the structures and functions of the present embodiments, the disclosure is illustrative only. Changes may be made in detail, especially in matters of shape, size, and arrangement of parts within the principles of the present embodiments, to the full extent indicated by the plain meaning of the terms in which the appended claims are expressed.

What is claimed is:

1. An artificial neural network comprising:
an input layer comprising a plurality of first artificial neurons;
a hidden layer comprising a plurality of second artificial neurons; and
an output layer comprising a plurality of third artificial neurons, the hidden layer positioned between the input layer and the output layer;
wherein, the hidden layer has a three-dimensional structure and is divided into a plurality of planes, the planes are parallel to and spaced apart from each other, and are arranged along an arranging direction between the input layer and the output layer, the second artificial neurons are positioned at the planes, each first artificial neuron is connected to the second artificial neuron of one plane adjacent to the input layer, each third artificial neuron is connected to the second artificial neurons of another plane adjacent to the output layer, the second artificial neurons of each plane are connected to each other, the second artificial neurons of each two adjacent planes are connected along the arranging direction of the planes, at least one of the second artificial neurons has at least six signal transmission directions along the arranging direction of the planes and toward other second artificial neurons of a same plane.

2. The artificial neural network of claim 1, wherein each first artificial neuron is connected to each second artificial neuron of the plane adjacent to the input layer.

3. The artificial neural network of claim 1, wherein each third artificial neuron is connected to each second artificial neuron of the plane adjacent to the output layer.

4. The artificial neural network of claim 1, wherein the first artificial neurons are connected to the second artificial neurons through first communication channels.

5. The artificial neural network of claim 1, wherein the second artificial neurons are connected to each other through second communication channels.

6. The artificial neural network of claim 1, wherein the third artificial neurons are connected to the second artificial neurons through third communication channels.

7. The artificial neural network of claim 1, wherein the input layer is a two-dimensional structure.

8. The artificial neural network of claim 1, wherein the output layer is a two-dimensional structure.

9. The artificial neural network of claim 1, wherein the hidden layer is cubic and has N planes along the arranging direction, each of the N planes is square and has M second artificial neurons, each side of each of the plurality of planes has P second artificial neurons, M=P×P, the second artificial neurons of each plane have 2P(P−1) signal connections, the second artificial neurons of each plane have M signal connections, the second artificial neurons of the hidden layer have [2P(P−1)+M](N−1) total signal connections.

10. The artificial neural network of claim 9, wherein each second artificial neuron at a corner of the hidden layer has three signal connections, each second artificial neuron at an outer surface of the hidden layer has five signal connections, one second artificial neurons at a geometrical center of the hidden layer has six signal connections.

11. An artificial neural network comprising:
an input layer comprising a plurality of first artificial neurons;
a hidden layer comprising a plurality of second artificial neurons; and
an output layer comprising a plurality of third artificial neurons, the hidden layer positioned between the input layer and the output layer;
wherein, the hidden layer has a three-dimensional structure and is divided into a plurality of planes, the planes are parallel to and spaced apart from each other, and are arranged along an arranging direction between the input layer and the output layer, the second artificial neurons are positioned at the planes, the first artificial neurons, the second artificial neurons, and the third artificial neurons are connected to each other, thereby allowing at least one of the second artificial neurons to have at least six signal transmission directions along the arranging direction of the planes and toward other second artificial neurons of a same plane.
